(19) United States
(12) Patent Application Publication
(10) Pub. No.: US 2017/0289900 A1
(43) Pub. Date: Oct. 5, 2017

(54) ADAPTIVE ACCESS POINT RESOURCE MANAGEMENT

(71) Applicants: Izoslav Tchigevsky, Portland, OR (US); Bahareh Sadeghi, Portland, OR (US); Seemab Kadri, Portland, OR (US)

(72) Inventors: Izoslav Tchigevsky, Portland, OR (US); Bahareh Sadeghi, Portland, OR (US); Seemab Kadri, Portland, OR (US)

(21) Appl. No.: 15/088,972

(22) Filed: Apr. 1, 2016

(51) Int. Cl. H04W 48/16; H04W 12/06

(52) U.S. Cl. CPC H04W 48/16; H04W 12/06; H04W 84/12

(57) ABSTRACT

This disclosure describes methods, apparatus, and systems related to devices (e.g., a smart AP) learning and/or estimating the resources required by client devices (e.g., an STA). This can be done, for example, by monitoring the informational statistics of the client device, such as the client device's traffic pattern and behavior. This information can be used to efficiently allocate resources and dynamically update the resources as needed, hence optimizing the limited resources available on the device and/or the client device.

### TECHNICAL FIELD

This disclosure generally relates to systems and methods for wireless communications and, more particularly, systems and methods adaptive resource management for wireless communication.

### BACKGROUND

Wireless devices are becoming widely prevalent and are increasingly requesting access to wireless channels. A next generation WLAN, IEEE 802.11ax or High-Efficiency WLAN (HEW), is under development. HEW utilizes Orthogonal Frequency-Division Multiple Access (OFDMA) in channel allocation. Central Wi-Fi stations, such as access points (APs), may be limited in the number of client devices they can support due to hardware and software limitations.

### BRIEF DESCRIPTION OF THE DRAWINGS

FIG. 1 shows an exemplary Internet-of-Things (IoT) network environment, in accordance with embodiments of the disclosure.

FIG. 2 shows a diagram representing device and client device exchanges that may provide the device information regarding the client device's resource requirements, in accordance with one or more example embodiments of the disclosure.

FIG. 3 shows a diagram of existing Access Point (AP) resource management techniques for various client devices.

FIG. 4 shows a diagram of example optimized and dynamic resource management for APs in accordance with one or more example embodiments of the disclosure.

FIG. 5 shows an example network environment in accordance with example embodiments of the systems and methods disclosed herein.

FIG. 6 shows an exemplary flowchart of the operation of an example device during a pre-association process, in accordance with one or more example embodiments of the disclosure.

FIG. 7 shows another exemplary flowchart of another aspect of the operation of an example device during an authentication/association process, in accordance with one or more example embodiments of the disclosure.

FIG. 8A shows another exemplary flowchart of another aspect of the operation of an example device during data exchange with a client device, in accordance with one or more example embodiments of the disclosure.

FIG. 8B shows another exemplary flowchart of another aspect of the operation of an exemplary device during data exchange with a client device, in accordance with one or more example embodiments of the disclosure.

FIG. 9 shows another exemplary flowchart of another aspect of the operation of an exemplary device receiving an explicit client device notification, in accordance with one or more example embodiments of the disclosure.

FIG. 10 illustrates a functional diagram of an example communication station that may be suitable for use as a user device, in accordance with one or more example embodiments of the disclosure.

FIG. 11 is a block diagram of an example machine upon which any of one or more techniques (e.g., methods) may be performed, in accordance with one or more embodiments of the disclosure.

### DETAILED DESCRIPTION

Example embodiments described herein provide certain systems, methods, and devices, for providing signaling information to Wi-Fi devices in various Wi-Fi networks, including, but not limited to, IEEE 802.11ax (referred to as HE or HEW).

The following description and the drawings sufficiently illustrate specific embodiments to enable those skilled in the art to practice them. Other embodiments may incorporate structural, logical, electrical, process, and other changes. Portions and features of some embodiments may be included in, or substituted for, those of other embodiments. Embodiments set forth in the claims encompass all available equivalents of those claims.

Conventional Wi-Fi device (e.g., Access Points (“APs”)) support a limited number of clients. One reason is that various standards (e.g., the IEEE 802.11 standards) specify that APs provide some basic service for all Wi-Fi stations (STAs), (e.g., Wi-Fi client devices). For instance, an AP can buffer traffic that comes from external networks or other client devices to a specific client device STA, if this STA is in power save mode. Thus, an AP may need to be prepared for worst case scenarios. For example, the APs may need to have enough buffers to maintain data arriving at a maximal rate (e.g., approximately 1 Gb/s) for maximal number of supported clients (e.g., 32), and for at maximal supported delivery traffic indication message (DTIM) period (e.g., approximately 300 milliseconds). This may require at least a large amount of random-access memory (RAM) to be allocated for this purpose. For example, with the data rates, number of client devices, and DTIM periods given in the example, approximately 400 MB of RAM may need to be allocated by the transmitting AP.

Approaches of enabling an AP to support client devices are often directed to pre-allocating a large (possibly maximal) amount of potentially required resources, for example, buffer space in the device. However, such approaches can limit the device's ability to support a large number of devices. With the increase of the Internet-of-Things (IoT) devices and the exponential increase in number of connected client devices, this can negatively impact the user experience (e.g., by requiring that the user use multiple APs or by limiting the number of connected devices) and/or increase the cost of devices.

Often the traffic requirements of client devices in a wireless network can be predictably analyzed by a device (e.g., a connected AP) based on the services they provide. Determining the services provided by the client device STAs can be a part of the discovery process, for example, the discovering process used in Wi-Fi Direct, WI-FI Direct Services (WFDS) Application Services Platform (ASP) frameworks, and ASP2 programs. For example, a device comprising an AP (referred to herein as a smart AP) for a smart home can determine the traffic requirements of client devices (e.g., various STAs) based on the services they provide; the information the device learns as part of the discovery process can then be used to allocate the required resources for the client devices. This is in contrast to conventional systems and methods, in which the device allocates a default buffer amount, for example, the maximum available in memory, for any given client device.

In one embodiment, a device (e.g., a smart AP) can learn and/or estimate the resources required by a client device (e.g., an STA) even if the service and application are not available. This can be done by monitoring the informational statistics of the client device, such as the client device's traffic pattern and behavior. In some aspects, examples of client device behavior can include (but not be limited to), specific packets that the client device sends to the AP, patterns of times of higher than normal activity of the client device, the location of the client device (for mobile client devices), and the like. This information can be used to efficiently allocate resources and dynamically update the resources as needed, hence optimizing the limited resources available on the device.

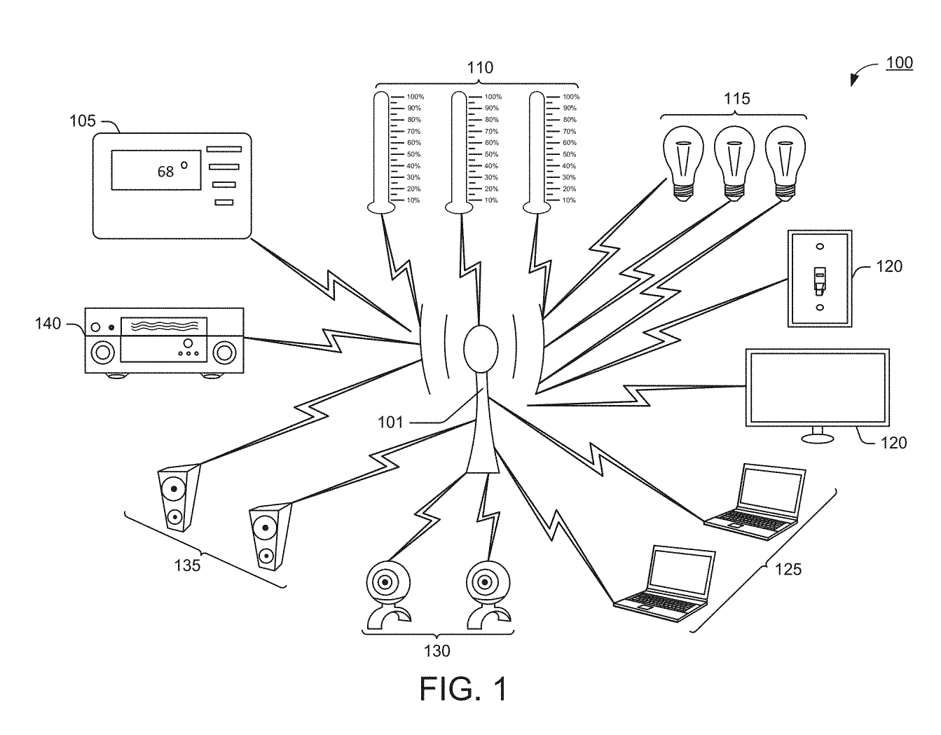

FIG. 1 shows an exemplary Internet-of-Things (IoT) network environment 100 in accordance with the disclosure. Specifically, FIG. 1 shows a diagram of an exemplary wireless device 101 (interchangeably referred to as an AP or a smart AP herein out) that can send and receive data with various client devices through different mechanisms, in accordance with the disclosure. IoT has led to an increased amount of WiFi clients serviced by the device 101, as represented by the figure. For example, a smart thermostat 105 may require several devices to be connected to WiFi, such as the thermostat itself and one or more sensors 110. In a smart home, each smart light bulb 115 can serve as a potentially client device. Similarly, each smart speaker 135 in the house can potentially serve a client device (e.g., for a six speakers system that equates to six client devices). Various other devices can also be a part of this IoT network environment 100, including but not limited to, smart televisions 120, laptops 125, cameras 130, and the like.

Additionally, different client devices can have different traffic patterns. Some client devices may require fewer resources from the device 101, allowing the device 101 to support a much larger number of client devices (e.g., up to hundreds of client devices) without substantially increasing the footprint of the device 101 itself.

The systems and methods herein disclose a device (e.g., a device 101, which may comprise an AP, such as a smart AP) using service information for the allocation and management of buffers and resources for client devices (e.g., client devices 105-140 of FIG. 1). In some embodiments, service information can be available to the device 101 at the time of association of a client device. In another embodiment, the service information can be available to the device 101 when discovery information is passed via the device 101 to the client device searching for particular services. The device can use this discovery information to allocate appropriate resources to the client device either statically (e.g., at the time of client device association) or dynamically (e.g., each time new information about the provided service becomes available). This can enable the optimization of buffers and other resources at the device and a reduction in the hardware cost of the device.

One advantage of the disclosed systems and methods is that they can enable lower cost network access devices, such as an AP or smart AP, that can serve more client devices. They can also allow more power-efficient behavior for client devices (e.g., various IoT devices), lead to less expensive implementation of those client devices in hardware and software, since, for example, the client devices can work with optimized devices.

In various embodiments, client devices can make use of the fact that the device is aware of their behavior. For example, the client devices can avoid unnecessary over-the-air activities and thus preserve power. For example, unnecessary over-the-air activities can include transmitting “keep-alive” frames by the device to the client device to maintain the operation of the client device.

In various embodiments, the allocated resources and operational parameters on the device and/or the client device can include, but not limited to, a buffer space (e.g., in memory), hardware for special handling of the client device (e.g., dedicated data queue hardware, hardware for offloading client device-specific processing from the device CPU to a device's WiFi card, and the like), or time reservations for over-the-air client device activities. For example, for client devices that have low power usage, the device can optimize its own channel access in order to minimize the period that the client devices are in the awake or active mode. In various embodiments, operational parameters can include, but not be limited to, one or more of a channel usage preference, a channel bandwidth usage, data rate, power usage, sleep/awake schedule, bandwidth, throughput, compression protocol, power requirement, and the like.

The term IoT is used to refer to any device (e.g., an appliance, a sensor, a house appliance, a vehicle, etc.) that may include a network interface associated with one or more network protocols, such as, Wi-Fi, Bluetooth, NFC, etc. An IoT device may transmit information to one or more other devices over a wired or wireless connection. An IoT device may also include a quick response code (QR), a radio-frequency identification (RFID) tag, an NFC tag, etc. The IoT device may also include, but not limited to, a radio circuitry, such as a transceiver that may operate at various modulation techniques, such, on-off keying (OOK), such as, amplitude shift keying (ASK) or frequency shift keying (FSK), or the like. Some example of IoT devices my include, but are not limited to, refrigerators, toasters, ovens, microwaves, freezers, dishwashers, dishes, hand tools, clothes washers, clothes dryers, furnaces, air conditioners, thermostats, televisions, light fixtures, vacuum cleaners, sprinklers, electricity meters, gas meters, etc. IoT devices may also include cell phones, desktop computers, laptop computers, tablet computers, personal digital assistants (PDAs), etc. Accordingly, the IoT network may be comprised of a combination of “legacy” Internet-accessible devices (e.g., laptop or desktop computers, cell phones, etc.) in addition to devices that do not typically have Internet-connectivity (e.g., dishwashers, etc.).

With reference back to FIG. 1, in the case of a light bulb client device, the data exchanges between the device and the smart light bulb client device can comprise short commands. Hence, the device may not need to allocate a large buffer for such a client device. Similarly, a thermostat client device may not need much buffer, as the control of a thermostat involves short commands. On the other hand, communication with the light bulb client device can be more time sensitive as compared to communication with a thermostat client device. In the case of a security camera client device, there can be a constant streaming of low data-rate video, which can determine how much buffer the device needs to allocate for the client device.

These and similar considerations are captured in and accounted for by the device using dynamic resource allocation, in accordance with the disclosed systems and methods.

In the disclosed systems and methods, information made available to a device regarding the services and capabilities of the client devices can be used to optimize the resource allocation at the device for the client devices. For example, if a client device comprising a light bulb (e.g., the light bulb 115 of FIG. 1) is connecting to the device, the device may expect intermittent, low data-rate traffic. On the other hand, when a client device comprising a security camera associates with the device, the device may expect high data-rate traffic, e.g., video streaming.

The systems and methods disclosed herein can also be applicable to soft AP devices. Soft APs can refer to smartphones, tablets, and the like, which can serve as an AP to connect with many low-power client devices in household environments. In such cases, optimized buffer management for the devices on the smart phone and/or tablet can be important for optimizing user experience.

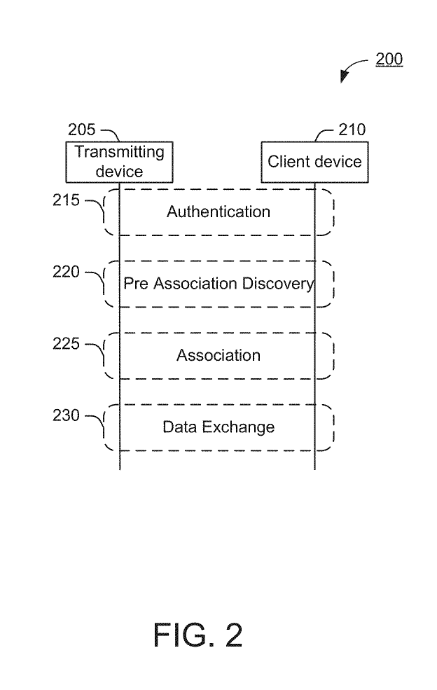

FIG. 2 shows a diagram 120 representing different ways a device 205 (e.g., the AP 101 of FIG. 1) can learn information about a client device 210 (e.g., any of the client devices 105-140 of FIG. 1) and allocate resources accordingly. The different ways the device can learn information can be broadly categorized as those relating to authentication 215, pre-authentication discovery 220, association 225, and data exchange 230, which will be elaborated on presently. In some embodiments, authentication can be a first step in network attachment. In authentication 215 the client device can establish its identity with the AP. In some instances, pre-authentication discovery 220 can refer to instances where the authentication 215 can be performed in advance so the AP is ready to let the client device join as soon as the client device is ready. Association 225 can refer to the process whereby the AP finalizes the security and bit rate options and establishes the data link between the client device and the AP. Data exchange 230 can then refer to the transmission and reception of data packets and/or frames between the AP and the client device.

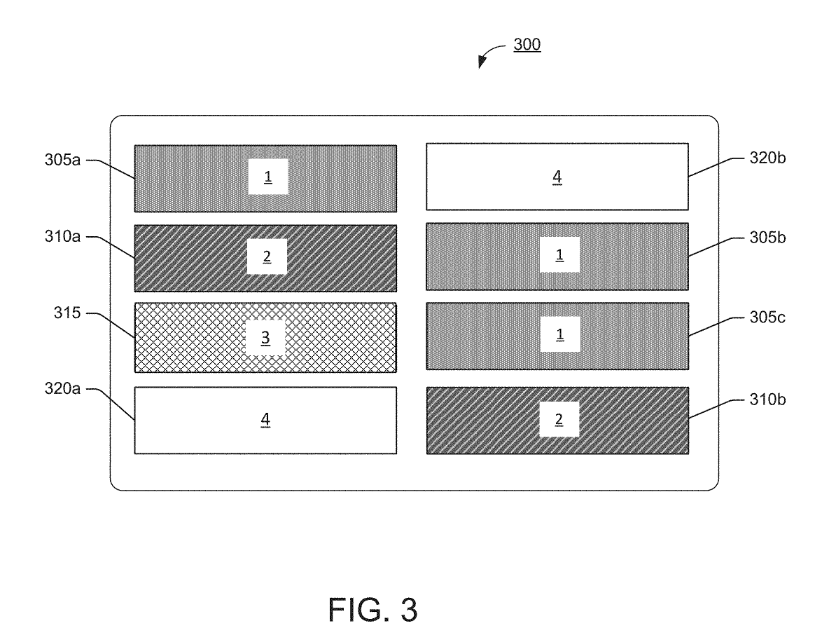

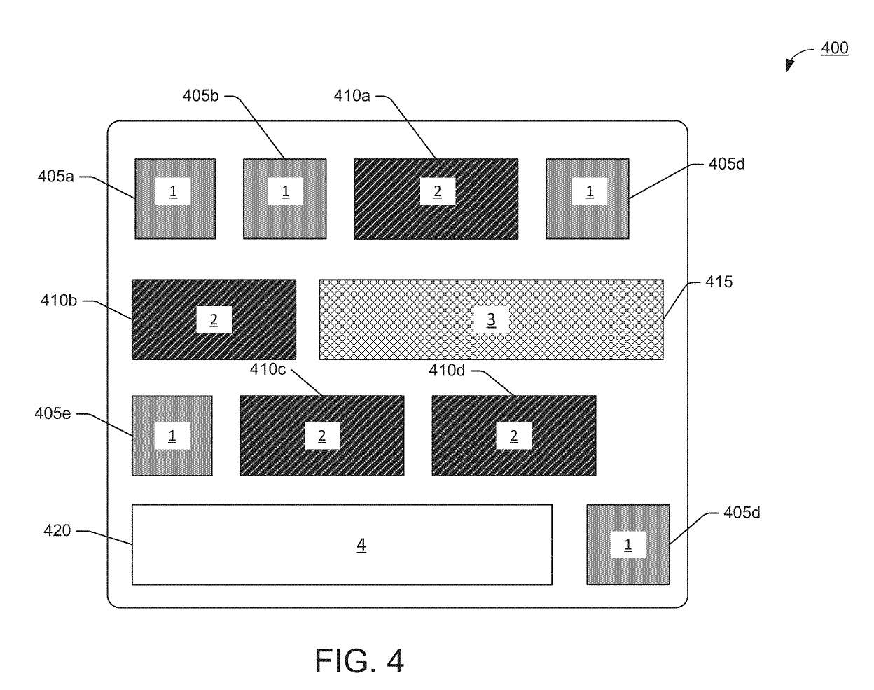

FIGS. 3 and 4 are diagrams for resource management using conventional systems and methods, as illustrated in FIG. 3, and an optimized and dynamic resource allocation system and method in accordance with the disclosure, as illustrated in FIG. 4.

Referring to FIG. 3, there is shown a diagram 300 of how an exemplary conventional device can organize the available resources of a device in an undifferentiated manner with respect to client device usage (represented by blocks 305-320). In other words, all of the blocks 305-320 representing the available resources of the AP for a given client device (for example, any of client devices 1-4), may be pre-allocated, distributed, and/or used equally for all client devices (1-4). For instance, an example low resource-usage device of a first type (for example, a lightbulb) represented as client 1 305a-c may have an equal pre-allocated share of AP resources (for example, channel bandwidth, memory, priority treatment of the client device, buffer space, and the like) as more resource-consuming second type of device (for example, a smart television) represented, for example, as client 2 310a-c. Accordingly, different types of devices (for example, type 1-type 4 shown in the figure) may be given the same resource allocation by the AP.

Alternatively, as shown in FIG. 4, the available resources of the AP for a similar set of client devices (for example, client devices 1-4), may be pre-allocated, distributed, and/or used differentially based on the client device type. Here, the available resources of the AP (represented by blocks 405-420) for the client devices can be divided more granularly based on the client device properties and needs, more so than in the situation described in FIG. 3. As such, given similar available resources (represented by blocks 405-420) for an AP device, a larger number of client devices can be associated with the device. Furthermore, the available resources of the AP (405-420) can be divided by a device type. For example, client devices of a first type 405a-d (e.g., smart light bulbs) may not require much in the way of resource allocation on the part of the device. Consequently, as represented by blocks 405a-d, numerous light bulbs may be supported by the device. Client devices of a second type 410a-b (e.g., security monitoring cameras) may generate comparatively large amounts of video content and consequently require more resources. Thus, as shown in the diagram 400, blocks 410a-b are larger with respect to the devices of the first type. In one embodiment, the available resources can comprise a dynamic buffer allocation for a given client (for example, a client 3) 415. In various embodiments, this dynamic buffer allocation for a given client 415 can comprise a larger resource allocation than either the client devices of the first type or the client devices of the second type. Similarly, additional device types can be supported by the device (not shown). In one embodiment, a dynamic buffer allocation 415 based on statistic collection and analysis for a given client device (e.g., a given client 4 320 of FIG. 3) can take up a portion of the resources of the device. In another embodiment, an allocation of buffer resources for legacy client devices 420 (e.g., devices that do not conform to the latest standards, and/or those devices which do not transmit additional information to the device besides basic connecting information exchange) may be made available. In one embodiment, this allocation of buffer for legacy client devices 420 may be a pre-determined amount that is static and can be changed by a user, for example, a user changing an AP device setting.

A way that a device can learn information about client devices can be as part of a pre-association discovery process (pre-association process 220 of FIG. 2). Before associating with the device, client devices seeking specific services can initiate a pre-association discovery process in order to find out about the services provided by the device, other client devices associated with the device, or by a basic service set (BSS) in general. For example, the Application Services Platform (ASP) protocol as defined in IEEE 802.11aq, Generic Advertisement Service (GAS), can serve as protocols used for pre-association service discovery. The information obtained by the device during service discovery request and/or responses can allow the device to learn the specific services/application the client device will be using.

Additionally, the device can report its compatibility to the client devices. This can be done, for example, with adaptive resource allocation using an information element (IE) in a Beacon and Probe Response (BPR). The client devices can similarly notify the device about the client device's behavior by sending a message to the AP, where the message may include, at least in part, an information element (IE) and/or a Probe Request. A probe request can refer to a special frame sent by the client device requesting information from the AP.

Another way that a device can learn information about client devices can be during authentication (e.g., authentication 215 of FIG. 2) and association (e.g., association 225 of FIG. 2) procedures. Client devices that wish to connect to an IoT network may need to be authenticated and then associate to a device. During the authentication and association procedure, the device can learn some of device capabilities, including for example, the maximum data rate supported by the client device. In one embodiment, GAS exchanges can be used in conjunction with authentication and association procedures to further learn of services supported by the client device.

In order to agree on a pre-determined behavior pattern between the device and the client device, the client device can describe its own desired behavior using an IE in an Association Request to the device. The device can report where it will use the collected information from the client device by sending a message to the client device, where the message may include, at least in part, an IE in an Association Response to the client device.

In another embodiment, the device 101 of FIG. 1 can determine information about client devices through data exchange (e.g., data exchange 230 of FIG. 2), for example, through determining statistics of client device activity during a connection with the client device.

In some embodiments, the devices may have information regarding the resource usage of a client device readily available. The traffic model of the client device can thus provide the device with the information needed for the dynamic optimization of its own resources. For example, the device may not be required to pre-allocate a fixed amount of resources to a client device; rather, the device can dynamically update resource allocation based on the statistical modeling of the client device's behavior.

In some embodiments, there may be two implementation modes for determining statistics of a client device by a device (e.g., an AP) based on activity during a connection between the device and the client device. The two modes may be a silent implementation mode and an explicit implementation mode. In a silent implementation mode, no explicit information is exchanged between the device and the client device. In the explicit implementation mode, the device can explicitly inform the client device that it will apply a pre-determined configuration based on discovered behavior of the client device. In one embodiment, the client device may be granted the ability to override the device's decision.

Another way that the device can determine information about client devices after connection establishment can be through explicit notification by the client device. This can be done, for example, using a dedicated new action frame. This may be important for client devices that change their behavior while connected. For example, a remote web camera can be switched from a camera sleeping mode state (e.g., “No Upload Traffic, Wait for infrequent incoming traffic once per 10 sec”) to a high upload traffic state when user activates the camera remotely.

Another way that the device can determine information about client devices can be through collecting information from broadcast/multicast service inquiry/advertisement messages.

The information determined by the device and/or the client device can include, for example: traffic type/data rate/duty cycle; power-save capabilities; and continues connection vs. intermittent connection preferences. In some embodiments, the device may be operating on the expectation that the client device will use connect-send/data-disconnect cycles instead of maintaining a constant connection with the device. For such client devices, the device may provide the service of maintaining the data between connections in memory.

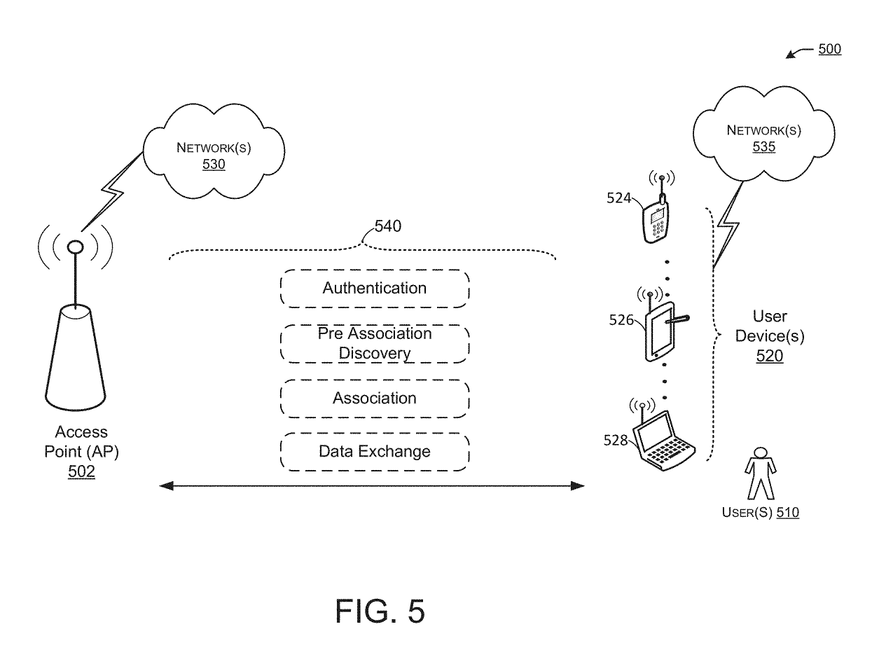

In various embodiments, client device types can be defined and used for the categorization of the myriad of IoT client device devices in order to classify them, for example, based on the client device's resource requirements. For example, a first type of device, referred to as type 1 devices, may require small buffer space and low latency, whereas a second type of device, referred to as type 2 devices, can require deterministic buffer allocation and medium latency tolerance, and so on FIG. 5 is a network diagram illustrating an example network environment, according to some example embodiments of the present disclosure. Wireless network 500 may include one or more devices 120 and one or more access point(s) (AP) 502, which may communicate in accordance with IEEE 802.11 communication standards, including IEEE 802.11ax. The device(s) 520 may be mobile devices that are non-stationary and do not have fixed locations.

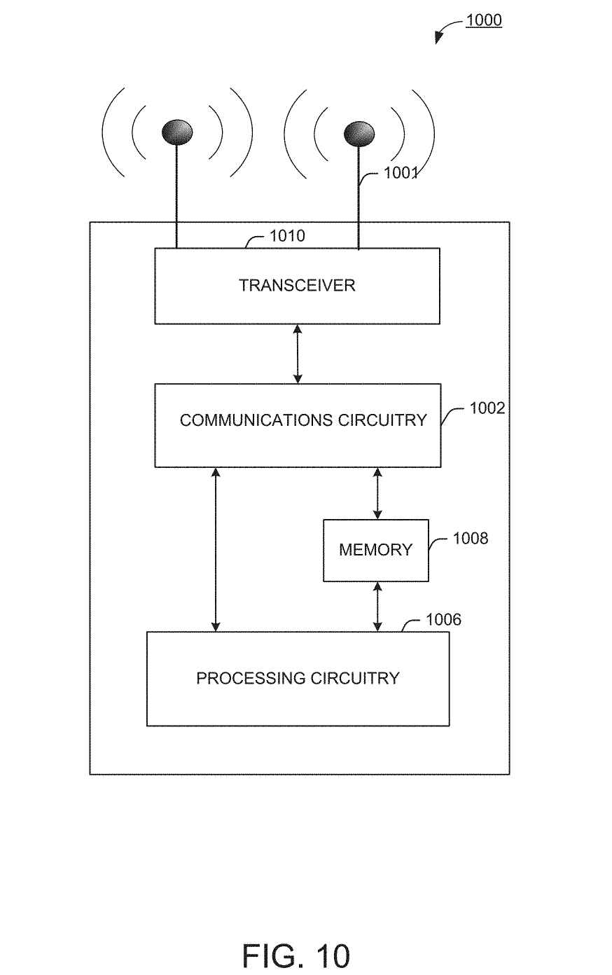

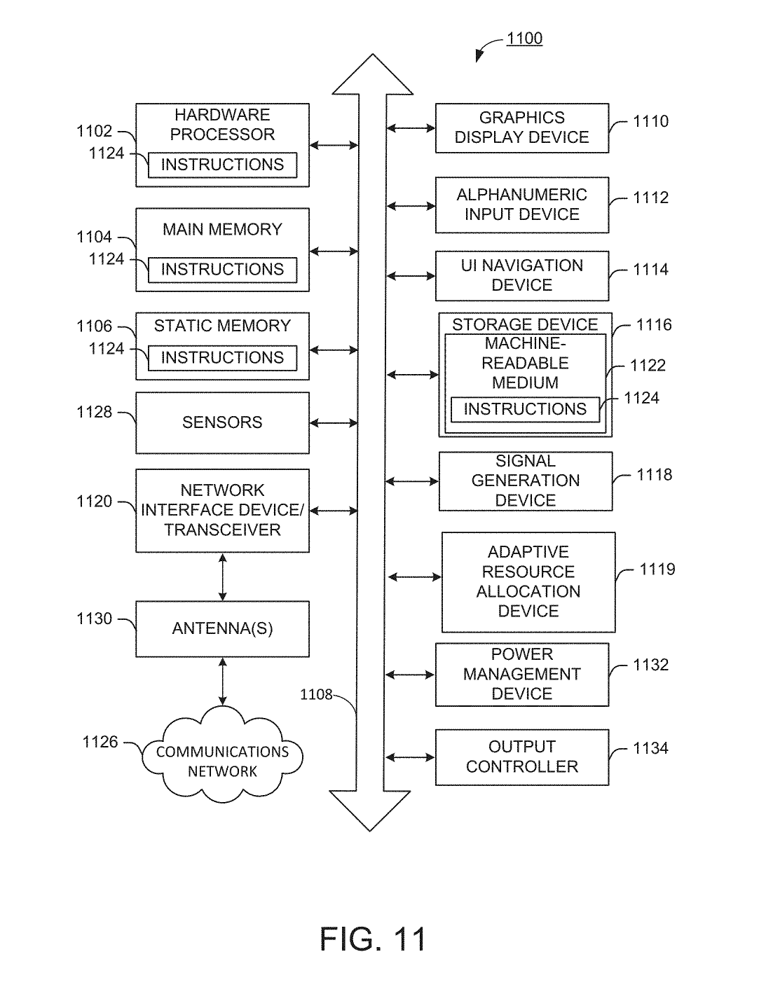

The user device(s) 520 (e.g., any one of the devices 524, 526, or 528) may include any suitable processor-driven user device including, but not limited to, a desktop user device, a laptop user device, a server, a router, a switch, an access point, a smartphone, a tablet, wearable wireless device (e.g., bracelet, watch, glasses, ring, etc.) and so forth. In some embodiments, the user devices 520 and AP 102 may include one or more computer systems similar to that of the functional diagram of FIG. 10 and/or the example machine/system of FIG. 11, to be discussed further.

Returning to FIG. 5, any of the user device(s) 520 (e.g., user devices 524, 526, 528), and AP 502 may be configured to communicate with each other via one or more communications networks 530 and/or 535 wirelessly or wired. Any of the communications networks 530 and/or 535 may include, but not limited to, any one of a combination of different types of suitable communications networks such as, for example, broadcasting networks, cable networks, public networks (e.g., the Internet), private networks, wireless networks, cellular networks, or any other suitable private and/or public networks. Further, any of the communications networks 530 and/or 535 may have any suitable communication range associated therewith and may include, for example, global networks (e.g., the Internet), metropolitan area networks (MANs), wide area networks (WANs), local area networks (LANs), or personal area networks (PANs). In addition, any of the communications networks 130 and/or 135 may include any type of medium over which network traffic may be carried including, but not limited to, coaxial cable, twisted-pair wire, optical fiber, a hybrid fiber coaxial (HFC) medium, microwave terrestrial transceivers, radio frequency communication mediums, white space communication mediums, ultra-high frequency communication mediums, satellite communication mediums, or any combination thereof.

Any of the user device(s) 520 (e.g., user devices 524, 526, 528), and AP 502 may include one or more communications antennae. Communications antenna may be any suitable type of antenna corresponding to the communications protocols used by the user device(s) 520 (e.g., user devices 524, 524 and 528), and AP 502. Some non-limiting examples of suitable communications antennas include Wi-Fi antennas, Institute of Electrical and Electronics Engineers (IEEE) 802.11 family of standards compatible antennas, directional antennas, non-directional antennas, dipole antennas, folded dipole antennas, patch antennas, multiple-input multiple-output (MIMO) antennas, or the like. The communications antenna may be communicatively coupled to a radio component to transmit and/or receive signals, such as communications signals to and/or from the user devices 520.

Any of the user devices 520 (e.g., user devices 524, 526, 528), and AP 502 may include any suitable radio and/or transceiver for transmitting and/or receiving radio frequency (RF) signals in the bandwidth and/or channels corresponding to the communications protocols utilized by any of the user device(s) 520 and AP 502 to communicate with each other. The radio components may include hardware and/or software to modulate and/or demodulate communications signals according to pre-established transmission protocols. The radio components may further have hardware and/or software instructions to communicate via one or more Wi-Fi and/or Wi-Fi direct protocols, as standardized by the Institute of Electrical and Electronics Engineers (IEEE) 802.11 standards. In certain example embodiments, the radio component, in cooperation with the communications antennas, may be configured to communicate via 2.4 GHz channels (e.g. 802.11b, 802.11g, 802.11n), 5 GHz channels (e.g. 802.11n, 802.11ac), or 60 GHZ channels (e.g. 802.11ad). In some embodiments, non-Wi-Fi protocols may be used for communications between devices, such as Bluetooth, dedicated short-range communication (DSRC), Ultra-High Frequency (UHF) (e.g. IEEE 802.11af, IEEE 802.22), white band frequency (e.g., white spaces), or other packetized radio communications. The radio component may include any known receiver and baseband suitable for communicating via the communications protocols. The radio component may further include a low noise amplifier (LNA), additional signal amplifiers, an analog-to-digital (A/D) converter, one or more buffers, and digital baseband.

Typically, when an AP (e.g., AP 502) establishes communication with one or more user devices 520 (e.g., user devices 524, 526, and/or 528), the AP 502 may communicate in the downlink direction by sending data frames. The data frames may be preceded by one or more preambles that may be part of one or more headers. These preambles may be used to allow the user device to detect a new incoming data frame from the AP 502. A preamble may be a signal used in network communications to synchronize transmission timing between two or more devices (e.g., between the APs and user devices). The communication between AP 502 and user devices 120 may include one or more communication stages 540. For example, the communication between the AP 502 and the user device 120 can include a pre-association and discovery related communication, an authentication related communication, an associated related communication, and general data exchange between the AP 502 and the user device 120. The resource allocation and optimization as described by the systems and methods disclosed herein may, for example, occur as a part of any of these communications.

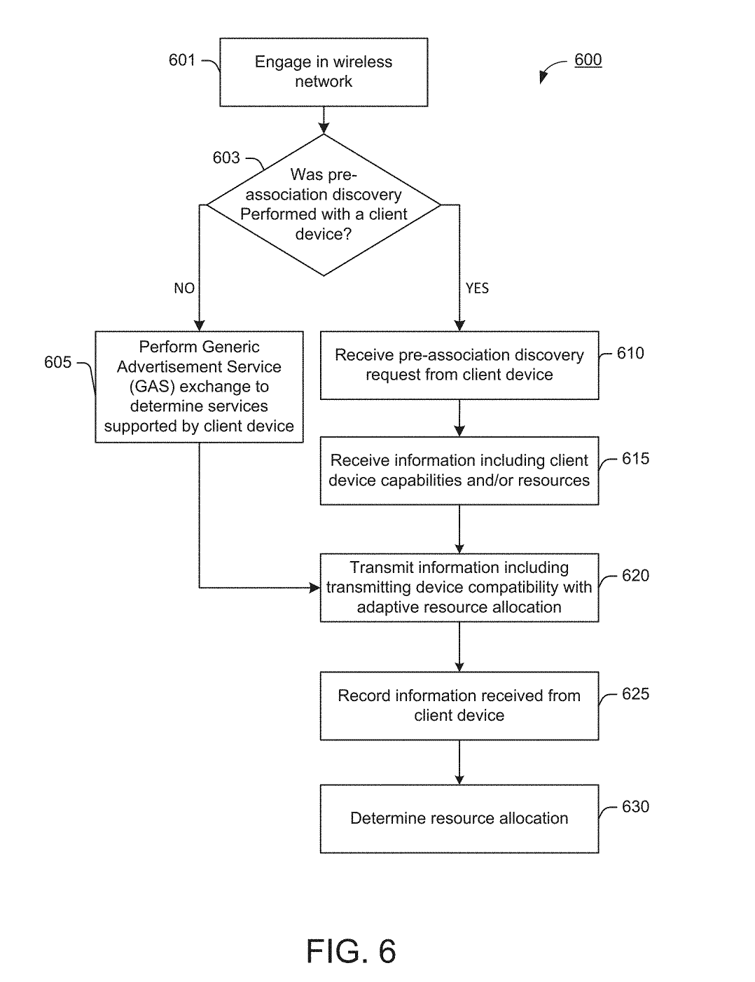

FIGS. 6-9 show representative flow charts of the operation of the devices and client device (interchangeably referred to as client devices herein) in accordance with the disclosure.

FIG. 6 shows an exemplary flowchart 600 of the operation of an exemplary device in accordance with aspects of the disclosure. In block 601, the device engages in a wireless network, e.g., the device turns on and performs beamforming, and the like. In block 603, the device may determine whether to perform a pre-association discovery with a client device. If the result of the determination in block 603 is that the per-association discovery with the client device will be performed, then in block 610, the device (a device 502, e.g., an AP or smart AP, as shown in FIG. 5 or the device 101 of FIG. 1) can receive a pre-association discovery request (for example, a pre-association discovery request can be part of the pre-association discovery 220 of FIG. 2) from a client device, e.g. a client device (e.g., client device 105-140, as shown in FIG. 1). In block 615, the device can receive information from the client device, including the capabilities and/or resources of the client device. For example, the device can receive an IE in the probe request including specific services and/or applications that the client device uses. Alternatively, if the result of the determination in block 603 is that the per-association discovery with the client device will be performed, then in block 605, the device can perform GAS exchange with the client device to determine the services supported by the client device. In block 620, the device can transmit information to the client device, including device compatibility with adaptive resource allocation. For example, the device can transmit an IE in a beacon and probe response, including information regarding the device's compatibility with adaptive resource allocation. In block 625, the device can record the information transmitted and/or received from the client device. Similarly the client device can record any information transmitted and/or received from the device. In block 630, the device can optimize resource allocation based on any of the preceding steps. For example, the device can optimize its own internal resource allocation or the resource allocation the client device. Alternatively or additionally, the device can change its own behavior or the behavior of the client device. The resource allocation and/or the behavior modification can occur based on any of the preceding steps, for example, any information transmitted and/or received from the device and/or the client device.

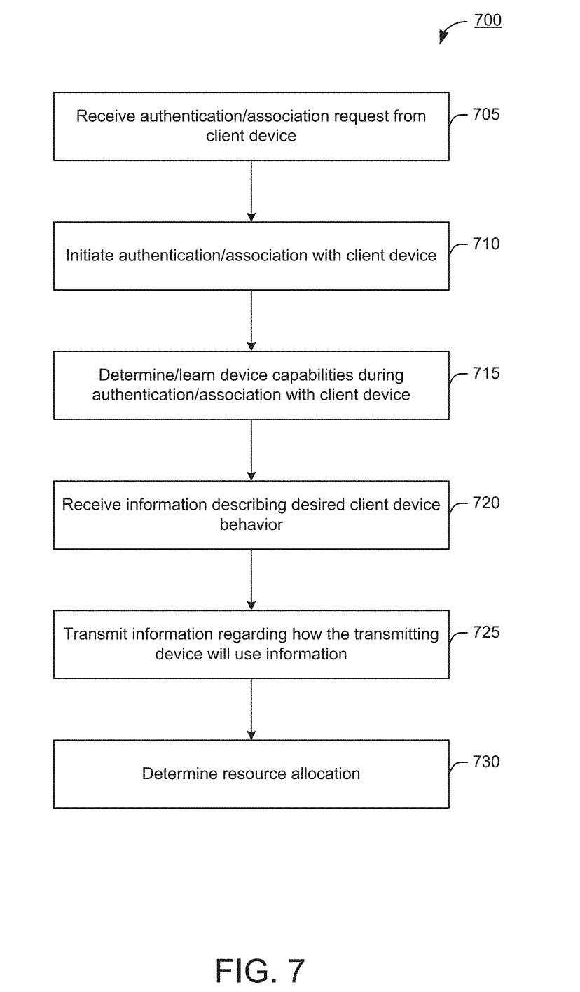

FIG. 7 shows another exemplary flowchart 700 of another aspect of the operation of an exemplary device (a device 502, e.g., an AP or smart AP, as shown in FIG. 5 or the device 101 of FIG. 1) in accordance with aspects of the disclosure. In block 705, the device can receive an authentication and/or association request from a client device, e.g. a client device (e.g. client device 105-140, as shown in FIG. 1). In block 710, the device can initiate authentication and/or association with the client device. In block 715, the device can determine the device capabilities of the client device during the authentication and/or association with the client device. For example, the device can determine various client device properties, for example, the channels that the client device can operate on, whether the client device can operate according to pre-determined standards, what data transfer rate the client devices can support, what type of content (for example, video, audio, raw data, and the like) that the client device is configured to send and receive, and the like. This determination can, for example, be made by exchanging frames with the client device specifically addressed to such inquiries, or can be inferred from data received from the client device as a normal part of the exchange between the device and the client device in accordance with various standards defining authentication and/or association protocols. In block 720, the device can receive information describing the desired behavior of the client device, e.g. how the client device wants to behave under certain network conditions. The desired behavior can comprise a set of pre-determined parameters associated with the client device and/or the device. For example, the device can receive an IE in the association request describing the desired behavior of the client device. In block 725, the device can transmit information to the client device describing how and where the device intends to use the information received from the client device as part of the authentication and/or association, and/or the information describing the desired behavior of the client device. For example, the device can transmit the information in an IE in an association response. Finally, in block 730, the device can optimize resource allocation with regards to the client device based on the preceding blocks (705-725). For example, the available resources of the AP (for example, see FIG. 4) for client devices may be pre-allocated, distributed, and/or used differentially based on identified information from the preceding blocks (705-725). In one embodiment, the available resources of the AP for the client devices can be divided more granularly based on the client device properties. For example, the available resources comprising a dynamic buffer allocation for a given client can comprise a larger resource allocation than either the client devices identified as being of a first type of client device.

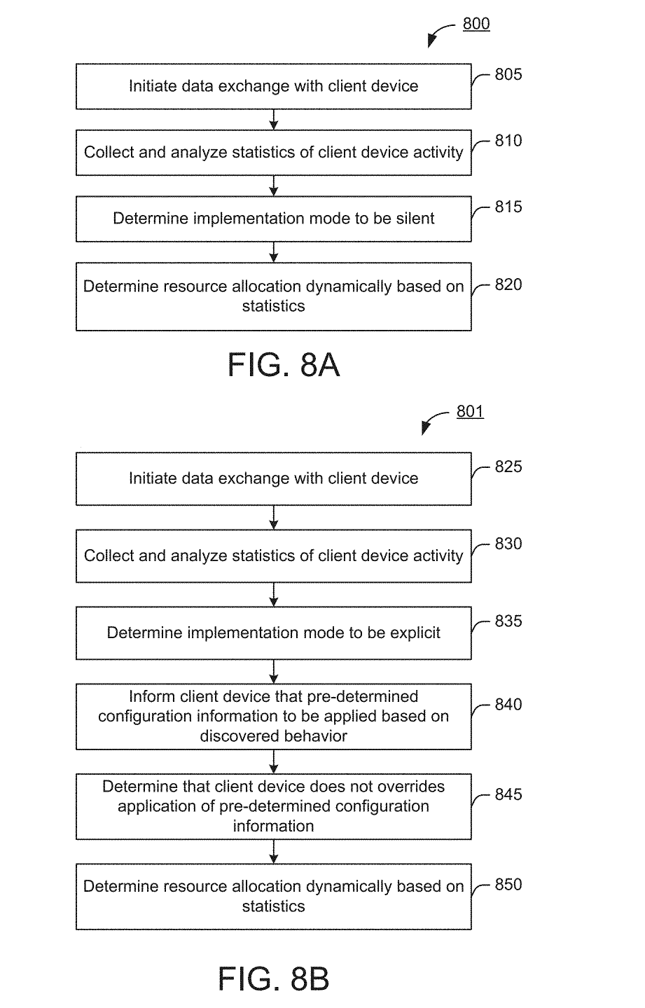

FIG. 8A shows another exemplary flowchart 800 of another aspect of the operation of an exemplary device, in accordance with aspects of the disclosure. In block 805, the device (a device 502, e.g., an AP or smart AP, as shown in FIG. 5 or the device 101 of FIG. 1) can engage in data exchange with a client device, e.g. a client device (e.g. client device 105-140, as shown in FIG. 1). In block 810, the device can collect information regarding statistics relating to the client device's activity. Statistics information can include, but not be limited to, information regarding when and how often the client device sends beacons, when and how often the client device exchanges information with other tertiary devices, what the average activity level of the client device is, when and how often the client device more busy than an average activity level for the client device, when and how often the client device transmits data having a size larger than a pre-determined threshold, and the like. In block 815, the device can determine the implementation mode to be a silent implementation. This can mean that the device does not communicate its collection and analysis of the client device's statistics to the client device. This can mean that the AP treats the client device as a passive device and does not inform the client device of the device's own activities with regard to the client device. In block 820, the device can dynamically (or statically in alternative embodiments) optimize resource allocation based on the statistics.

FIG. 8B shows another exemplary flowchart 801 of another aspect of the operation of an exemplary device in accordance with aspects of the disclosure. In block 825, the device (a device 502, e.g., an AP or smart AP, as shown in FIG. 5 or the device 101 of FIG. 1) can engage in data exchange with a client device, e.g. a client device (e.g. client device 105-140, as shown in FIG. 1). In block 830, the device can collect information regarding statistics relating to the client device's activity. Statistics information can include, but not be limited to, information regarding when and how often the client device sends beacons, when and how often the client device exchanges information with other tertiary devices, what the average activity level of the client device is, when and how often the client device more busy than an average activity level for the client device, when and how often the client device transmits data having a size larger than a pre-determined threshold, and the like. In block 835, the device can determine the implementation mode to be explicit. This can mean that the AP treats the client device as an active device and informs the client device of the device's own activities with regard to the client device. In block 840, the device can inform the client device that pre-determined configuration information can be applied to the client device based on discovered behavior of the client device. Such pre-determined configuration information can include, but not be limited to, a pre-allocated channel bandwidth for the client device to communicate with the device, a pre-determined data transfer rate for the client device to communicate with the device, a pre-determined content type (for example, video, audio, and the like) for the client device to communicate with the device, and the like. The application of the configuration information to the client device can occur via instructions sent by the device to the client device that the client device can execute to apply the pre-determined configuration information to the client device. In one embodiment, discovered behavior of the client device can include, but not be limited to, information regarding when and how often the client device sends beacons, when and how often the client device exchanges information with other tertiary devices, what the average activity level of the client device is, when and how often the client device more busy than an average activity level for the client device, when and how often the client device transmits data having a size larger than a pre-determined threshold, and the like. At this point, the device can allow the client device to override the application of the pre-determined configuration information (not shown in the flow chart). For example, the client device may determine to override the application of the pre-determined configuration information by the device because the client device has high priority data that it determines to transmit to the device on a high bandwidth channel, and the client device would otherwise be prevented from transmitting the high priority information to the device on the high bandwidth channels. In another example, the client device determine to override the application of the pre-determined configuration information by the device because the client device has a setting which a user can specifically request not to allow the device to apply any pre-determined configuration information to the client device. In block 845, the device can determine that the client device did not override the application of the pre-determined configuration information. In block 850, the device can dynamically (or statically in alternative embodiments) optimize resource allocation based on the statistics. For example, the available resources of the AP (for example, see FIG. 4) for client devices may be pre-allocated, distributed, and/or used differentially based on identified information from the preceding blocks (for example, any one of blocks 825-845). In one embodiment, the available resources of the AP for the client devices can be divided more granularly based on the client device properties. For example, the available resources comprising a dynamic buffer allocation for a given client can comprise a larger resource allocation than either the client devices identified as being of a first type of client device.

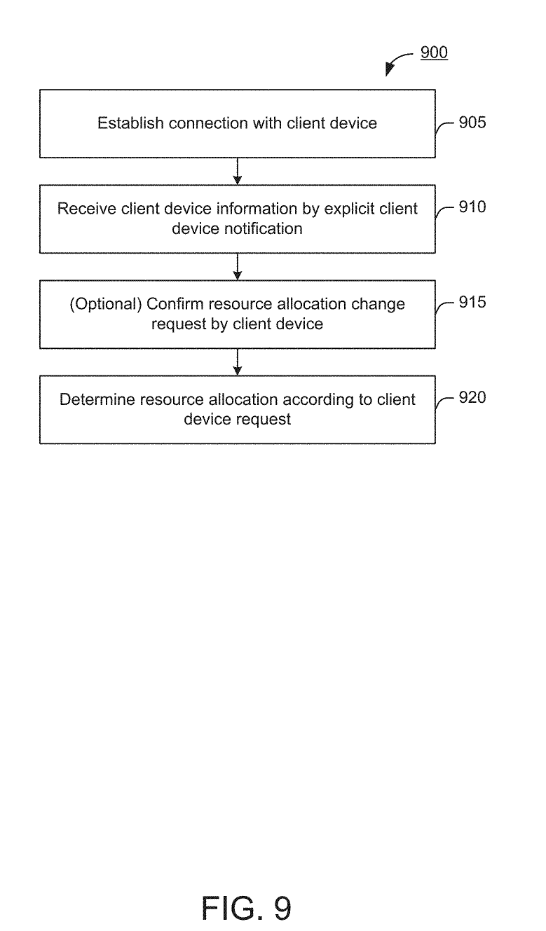

FIG. 9 shows another exemplary flowchart of another aspect of the operation of an exemplary device in accordance with aspects of the disclosure. In block 905, the device can establish a connection with a client device. In block 910, the device can receive client device information by explicit client device notification. In one embodiment, this explicit client device notification can include the client device sending data frame(s) to the device where the data frame(s) include fields that describe the client device. For example, this information can include computer instructions that code for a request for resource allocation change based on the client device's desired behavior. Such desired behavior can include, but not be limited to, preferred channel bandwidth for the client device to use during communication with the device, preferred frequency and timing for the client device engage in communication with the device, and the like. In block 915, the device can optionally confirm the resource allocation change request of the client device. The device can do this, for example, using a new action frame. The device can sent this action frame to the client device to provide the confirmation. In block 920, the device can optimize resource allocation according the client device's request. For example, the available resources of the AP (for example, see FIG. 4) for client devices may be pre-allocated, distributed, and/or used differentially based on identified information from the preceding blocks (for example, any one of blocks 905-915). In one embodiment, the available resources of the AP for the client devices can be divided more granularly based on the client device properties. For example, the available resources comprising a dynamic buffer allocation for a given client can comprise a larger resource allocation than either the client devices identified as being of a first type of client device.

FIG. 10 shows a functional diagram of an exemplary communication station 1000 in accordance with some embodiments. In one embodiment, FIG. 10 illustrates a functional block diagram of a communication station that may be suitable for use as an AP 102 (FIG. 5) or communication station user device 120 (FIG. 5) in accordance with some embodiments. The communication station 1000 may also be suitable for use as a handheld device, mobile device, cellular telephone, smartphone, tablet, netbook, wireless terminal, laptop computer, wearable computer device, femtocell, High Data Rate (HDR) subscriber station, access point, access terminal, or other personal communication system (PCS) device.

The communication station 1000 may include communications circuitry 1002 and a transceiver 1010 for transmitting and receiving signals to and from other communication stations using one or more antennas 1001. The communications circuitry 1002 may include circuitry that can operate the physical layer communications and/or medium access control (MAC) communications for controlling access to the wireless medium, and/or any other communications layers for transmitting and receiving signals. The communication station 1000 may also include processing circuitry 1006 and memory 1008 arranged to perform the operations described herein. In some embodiments, the communications circuitry 1002 and the processing circuitry 1006 may be configured to perform operations detailed in FIGS. 6-9.

In accordance with some embodiments, the communications circuitry 1002 may be arranged to contend for a wireless medium and configure frames or packets for communicating over the wireless medium. The communications circuitry 1002 may be arranged to transmit and receive signals. The communications circuitry 1002 may also include circuitry for modulation/demodulation, upconversion/downconversion, filtering, amplification, etc. In some embodiments, the processing circuitry 1006 of the communication station 1000 may include one or more processors. In other embodiments, two or more antennas 1001 may be coupled to the communications circuitry 1002 arranged for sending and receiving signals. The memory 1008 may store information for configuring the processing circuitry 1006 to perform operations for configuring and transmitting message frames and performing the various operations described herein. The memory 1008 may include any type of memory, including non-transitory memory, for storing information in a form readable by a machine (e.g., a computer). For example, the memory 1008 may include a computer-readable storage device may, read-only memory (ROM), random-access memory (RAM), magnetic disk storage media, optical storage media, flash-memory devices and other storage devices and media.

In some embodiments, the communication station 1000 may be part of a portable wireless communication device, such as a personal digital assistant (PDA), a laptop or portable computer with wireless communication capability, a web tablet, a wireless telephone, a smartphone, a wireless headset, a pager, an instant messaging device, a digital camera, an access point, a television, a medical device (e.g., a heart rate monitor, a blood pressure monitor, etc.), a wearable computer device, or another device that may receive and/or transmit information wirelessly.

In some embodiments, the communication station 1000 may include one or more antennas 1001. The antennas 1001 may include one or more directional or omnidirectional antennas, including, for example, dipole antennas, monopole antennas, patch antennas, loop antennas, microstrip antennas, or other types of antennas suitable for transmission of RF signals. In some embodiments, instead of two or more antennas, a single antenna with multiple apertures may be used. In these embodiments, each aperture may be considered a separate antenna. In some multiple-input multiple-output (MIMO) embodiments, the antennas may be effectively separated for spatial diversity and the different channel characteristics that may result between each of the antennas and the antennas of a transmitting station.

In some embodiments, the communication station 1000 may include one or more of a keyboard, a display, a non-volatile memory port, multiple antennas, a graphics processor, an application processor, speakers, and other mobile device elements. The display may be an LCD screen including a touch screen.

Although the communication station 1000 is illustrated as having several separate functional elements, two or more of the functional elements may be combined and may be implemented by combinations of software-configured elements, such as processing elements including digital signal processors (DSPs), and/or other hardware elements. For example, some elements may include one or more microprocessors, DSPs, field-programmable gate arrays (FPGAs), application specific integrated circuits (ASICs), radio-frequency integrated circuits (RFICs) and combinations of various hardware and logic circuitry for performing at least the functions described herein. In some embodiments, the functional elements of the communication station 1000 may refer to one or more processes operating on one or more processing elements.

Certain embodiments may be implemented in one or a combination of hardware, firmware, and software. Other embodiments may also be implemented as instructions stored on a computer-readable storage device, which may be read and executed by at least one processor to perform the operations described herein. A computer-readable storage device may include any non-transitory memory mechanism for storing information in a form readable by a machine (e.g., a computer). For example, a computer-readable storage device may include read-only memory (ROM), random-access memory (RAM), magnetic disk storage media, optical storage media, flash-memory devices, and other storage devices and media. In some embodiments, the communication station 1000 may include one or more processors and may be configured with instructions stored on a computer-readable storage device memory.

FIG. 11 illustrates a block diagram of an example of a machine 1100 or system upon which any one or more of the techniques (e.g., methodologies) discussed herein may be performed. In other embodiments, the machine 1100 may operate as a standalone device or may be connected (e.g., networked) to other machines. In a networked deployment, the machine 1100 may operate in the capacity of a server machine, a client machine, or both in server-client network environments. In an example, the machine 1100 may act as a peer machine in peer-to-peer (P2P) (or other distributed) network environments. The machine 1000 may be a personal computer (PC), a tablet PC, a set-top box (STB), a personal digital assistant (PDA), a mobile telephone, wearable computer device, a web appliance, a network router, switch or bridge, or any machine capable of executing instructions (sequential or otherwise) that specify actions to be taken by that machine, such as a base station. Further, while only a single machine is illustrated, the term “machine” shall also be taken to include any collection of machines that individually or jointly execute a set (or multiple sets) of instructions to perform any one or more of the methodologies discussed herein, such as cloud computing, software as a service (SaaS), or other computer cluster configurations.

Examples, as described herein, may include or may operate on logic or a number of components, modules, or mechanisms. Modules are tangible entities (e.g., hardware) capable of performing specified operations when operating. A module includes hardware. In an example, the hardware may be specifically configured to carry out a specific operation (e.g., hardwired). In another example, the hardware may include configurable execution units (e.g., transistors, circuits, etc.) and a computer readable medium containing instructions where the instructions configure the execution units to carry out a specific operation when in operation. The configuring may occur under the direction of the executions units or a loading mechanism. Accordingly, the execution units are communicatively coupled to the computer-readable medium when the device is operating. In this example, the execution units may be a member of more than one module. For example, under operation, the execution units may be configured by a first set of instructions to implement a first module at one point in time and reconfigured by a second set of instructions to implement a second module at a second point in time.

The machine (e.g., computer system) 1100 may include a hardware processor 1102 (e.g., a central processing unit (CPU), a graphics processing unit (GPU), a hardware processor core, or any combination thereof), a main memory 1004 and a static memory 1106, some or all of which may communicate with each other via an interlink (e.g., bus) 1108. The machine 1100 may further include a power management device 1132, a graphics display device 1110, an alphanumeric input device 1112 (e.g., a keyboard), and a user interface (UI) navigation device 1114 (e.g., a mouse). In an example, the graphics display device 1110, alphanumeric input device 1112, and UI navigation device 1114 may be a touch screen display. The machine 1100 may additionally include a storage device (i.e., drive unit) 1116, a signal generation device 1118 (e.g., a speaker), an adaptive resource management device 1119, a network interface device/transceiver 1120 coupled to antenna(s) 1130, and one or more sensors 1128, such as a global positioning system (GPS) sensor, compass, accelerometer, or other sensor. The machine 1100 may include an output controller 1134, such as a serial (e.g., universal serial bus (USB), parallel, or other wired or wireless (e.g., infrared (IR), near field communication (NFC), etc.) connection to communicate with or control one or more peripheral devices (e.g., a printer, card reader, etc.)).

The storage device 1116 may include a machine readable medium 1122 on which is stored one or more sets of data structures or instructions 1124 (e.g., software) embodying or utilized by any one or more of the techniques or functions described herein. The instructions 1124 may also reside, completely or at least partially, within the main memory 1104, within the static memory 1106, or within the hardware processor 1102 during execution thereof by the machine 1100. In an example, one or any combination of the hardware processor 1102, the main memory 1104, the static memory 1106, or the storage device 1116 may constitute machine-readable media.

The adaptive resource management device 1119 may be configured to execute instructions to receive a request from a client device; exchange information with the client device; and optimize resource allocation at one or more of the device and the client device based on the exchanged information. Moreover, the adaptive resource management device 1119 may be configured to exchange data with a client device; collect and analyze statistics associated with at least one activity of the client device; determine an implementation mode for further data exchange with the client device; and optimize resource allocation at one or more of the device and the client device based on the statistics and the implementation mode. Furthermore, the adaptive resource management device 1199 may be configured to establish a connection with a client device; receive client device information by explicit client device notification; and optimize resource allocation at one or more of the device and the client device based on a client device request.

It is understood that the above are only a subset of what the adaptive resource management device 1119 may be configured to perform and that other functions included throughout this disclosure may also be performed by the adaptive resource management device 1119.

While the machine-readable medium 1122 is illustrated as a single medium, the term “machine-readable medium” may include a single medium or multiple media (e.g., a centralized or distributed database, and/or associated caches and servers) configured to store the one or more instructions 1124.

The term “machine-readable medium” may include any medium that is capable of storing, encoding, or carrying instructions for execution by the machine 1100 and that cause the machine 1100 to perform any one or more of the techniques of the present disclosure, or that is capable of storing, encoding, or carrying data structures used by or associated with such instructions. Non-limiting machine-readable medium examples may include solid-state memories and optical and magnetic media. In an example, a massed machine-readable medium includes a machine-readable medium with a plurality of particles having resting mass. Specific examples of massed machine-readable media may include non-volatile memory, such as semiconductor memory devices (e.g., Electrically Programmable Read-Only Memory (EPROM), or Electrically Erasable Programmable Read-Only Memory (EEPROM)) and flash memory devices; magnetic disks, such as internal hard disks and removable disks; magneto-optical disks; and CD-ROM and DVD-ROM disks.

The instructions 1124 may further be transmitted or received over a communications network 1126 using a transmission medium via the network interface device/transceiver 1120 utilizing any one of a number of transfer protocols (e.g., frame relay, internet protocol (IP), transmission control protocol (TCP), user datagram protocol (UDP), hypertext transfer protocol (HTTP), etc.). Example communications networks may include a local area network (LAN), a wide area network (WAN), a packet data network (e.g., the Internet), mobile telephone networks (e.g., cellular networks), Plain Old Telephone (POTS) networks, wireless data networks (e.g., Institute of Electrical and Electronics Engineers (IEEE) 802.11 family of standards known as Wi-Fi®, IEEE 802.16 family of standards known as WiMax®), IEEE 802.15.4 family of standards, and peer-to-peer (P2P) networks, among others. In an example, the network interface device/transceiver 1120 may include one or more physical jacks (e.g., Ethernet, coaxial, or phone jacks) or one or more antennas to connect to the communications network 1126. In an example, the network interface device/transceiver 1120 may include a plurality of antennas to wirelessly communicate using at least one of single-input multiple-output (SIMO), multiple-input multiple-output (MIMO), or multiple-input single-output (MISO) techniques. The term “transmission medium” shall be taken to include any intangible medium that is capable of storing, encoding, or carrying instructions for execution by the machine 1100 and includes digital or analog communications signals or other intangible media to facilitate communication of such software. The operations and processes described and shown above may be carried out or performed in any suitable order as desired in various implementations. Additionally, in certain implementations, at least a portion of the operations may be carried out in parallel. Furthermore, in certain implementations, less than or more than the operations described may be performed.

The word “exemplary” is used herein to mean “serving as an example, instance, or illustration.” Any embodiment described herein as “exemplary” is not necessarily to be construed as preferred or advantageous over other embodiments. The terms “computing device”, “user device”, “communication station”, “station”, “handheld device”, “mobile device”, “wireless device” and “user equipment” (UE) as used herein refers to a wireless communication device such as a cellular telephone, smartphone, tablet, netbook, wireless terminal, laptop computer, a femtocell, High Data Rate (HDR) subscriber station, access point, printer, point of sale device, access terminal, or other personal communication system (PCS) device. The device may be either mobile or stationary.

As used within this document, the term “communicate” is intended to include transmitting, or receiving, or both transmitting and receiving. This may be particularly useful in claims when describing the organization of data that is being transmitted by one device and received by another, but only the functionality of one of those devices is required to infringe the claim. Similarly, the bidirectional exchange of data between two devices (both devices transmit and receive during the exchange) may be described as ‘communicating’, when only the functionality of one of those devices is being claimed. The term “communicating” as used herein with respect to a wireless communication signal includes transmitting the wireless communication signal and/or receiving the wireless communication signal. For example, a wireless communication unit, which is capable of communicating a wireless communication signal, may include a wireless transmitter to transmit the wireless communication signal to at least one other wireless communication unit, and/or a wireless communication receiver to receive the wireless communication signal from at least one other wireless communication unit.

The term “access point” (AP) as used herein may be a fixed station. An access point may also be referred to as an access node, a base station, or some other similar terminology known in the art. An access terminal may also be called a mobile station, user equipment (UE), a wireless communication device, or some other similar terminology known in the art. Embodiments disclosed herein generally pertain to wireless networks. Some embodiments can relate to wireless networks that operate in accordance with one of the IEEE 802.11 standards.

Some embodiments may be used in conjunction with various devices and systems, for example, a Personal Computer (PC), a desktop computer, a mobile computer, a laptop computer, a notebook computer, a tablet computer, a server computer, a handheld computer, a handheld device, a Personal Digital Assistant (PDA) device, a handheld PDA device, an on-board device, an off-board device, a hybrid device, a vehicular device, a non-vehicular device, a mobile or portable device, a consumer device, a non-mobile or non-portable device, a wireless communication station, a wireless communication device, a wireless Access Point (AP), a wired or wireless router, a wired or wireless modem, a video device, an audio device, an audio-video (A/V) device, a wired or wireless network, a wireless area network, a Wireless Video Area Network (WVAN), a Local Area Network (LAN), a Wireless LAN (WLAN), a Personal Area Network (PAN), a Wireless PAN (WPAN), and the like.

Some embodiments may be used in conjunction with one way and/or two-way radio communication systems, cellular radio-telephone communication systems, a mobile phone, a cellular telephone, a wireless telephone, a Personal Communication Systems (PCS) device, a PDA device which incorporates a wireless communication device, a mobile or portable Global Positioning System (GPS) device, a device which incorporates a GPS receiver or transceiver or chip, a device which incorporates an RFID element or chip, a Multiple Input Multiple Output (MIMO) transceiver or device, a Single Input Multiple Output (SIMO) transceiver or device, a Multiple Input Single Output (MISO) transceiver or device, a device having one or more internal antennas and/or external antennas, Digital Video Broadcast (DVB) devices or systems, multi-standard radio devices or systems, a wired or wireless handheld device, e.g., a Smartphone, a Wireless Application Protocol (WAP) device, or the like.

Some embodiments may be used in conjunction with one or more types of wireless communication signals and/or systems following one or more wireless communication protocols, for example, Radio Frequency (RF), Infra Red (IR), Frequency-Division Multiplexing (FDM), Orthogonal FDM (OFDM), Time-Division Multiplexing (TDM), Time-Division Multiple Access (TDMA), Extended TDMA (E-TDMA), General Packet Radio Service (GPRS), extended GPRS, Code-Division Multiple Access (CDMA), Wideband CDMA (WCDMA), CDMA 2000, single-carrier CDMA, multi-carrier CDMA, Multi-Carrier Modulation (MDM), Discrete Multi-Tone (DMT), Bluetooth®, Global Positioning System (GPS), Wi-Fi, Wi-Max, ZigBee™, Ultra-Wideband (UWB), Global System for Mobile communication (GSM), 2G, 2.5G, 3G, 3.5G, 4G, Fifth Generation (5G) mobile networks, 3GPP, Long Term Evolution (LTE), LTE advanced, Enhanced Data rates for GSM Evolution (EDGE), or the like. Other embodiments may be used in various other devices, systems, and/or networks.

Various embodiments may be implemented fully or partially in software and/or firmware. This software and/or firmware may take the form of instructions contained in or on a non-transitory computer-readable storage medium. Those instructions may then be read and executed by one or more processors to enable performance of the operations described herein. The instructions may be in any suitable form, such as but not limited to source code, compiled code, interpreted code, executable code, static code, dynamic code, and the like. Such a computer-readable medium may include any tangible non-transitory medium for storing information in a form readable by one or more computers, such as but not limited to read only memory (ROM); random access memory (RAM); magnetic disk storage media; optical storage media; a flash memory, etc.

Certain aspects of the disclosure are described above with reference to block and flow diagrams of systems, methods, apparatuses, and/or computer program products according to various implementations. It will be understood that one or more blocks of the block diagrams and flow diagrams, and combinations of blocks in the block diagrams and the flow diagrams, respectively, can be implemented by computer-executable program instructions. Likewise, some blocks of the block diagrams and flow diagrams may not necessarily need to be performed in the order presented, or may not necessarily need to be performed at all, according to some implementations.

These computer-executable program instructions may be loaded onto a special-purpose computer or other particular machine, a processor, or other programmable data processing apparatus to produce a particular machine, such that the instructions that execute on the computer, processor, or other programmable data processing apparatus create means for implementing one or more functions specified in the flow diagram block or blocks. These computer program instructions may also be stored in a computer-readable storage media or memory that can direct a computer or other programmable data processing apparatus to function in a particular manner, such that the instructions stored in the computer-readable storage media produce an article of manufacture including instruction means that implement one or more functions specified in the flow diagram block or blocks. As an example, certain implementations may provide for a computer program product, comprising a computer-readable storage medium having a computer-readable program code or program instructions implemented therein, said computer-readable program code adapted to be executed to implement one or more functions specified in the flow diagram block or blocks. The computer program instructions may also be loaded onto a computer or other programmable data processing apparatus to cause a series of operational elements or steps to be performed on the computer or other programmable apparatus to produce a computer-implemented process such that the instructions that execute on the computer or other programmable apparatus provide elements or steps for implementing the functions specified in the flow diagram block or blocks.

Accordingly, blocks of the block diagrams and flow diagrams support combinations of means for performing the specified functions, combinations of elements or steps for performing the specified functions and program instruction means for performing the specified functions. It will also be understood that each block of the block diagrams and flow diagrams, and combinations of blocks in the block diagrams and flow diagrams, can be implemented by special-purpose, hardware-based computer systems that perform the specified functions, elements or steps, or combinations of special-purpose hardware and computer instructions.

Conditional language, such as, among others, “can,” “could,” “might,” or “may,” unless specifically stated otherwise, or otherwise understood within the context as used, is generally intended to convey that certain implementations could include, while other implementations do not include, certain features, elements, and/or operations. Thus, such conditional language is not generally intended to imply that features, elements, and/or operations are in any way required for one or more implementations or that one or more implementations necessarily include logic for deciding, with or without user input or prompting, whether these features, elements, and/or operations are included or are to be performed in any particular implementation.

Many modifications and other implementations of the disclosure set forth herein will be apparent having the benefit of the teachings presented in the foregoing descriptions and the associated drawings. Therefore, it is to be understood that the disclosure is not to be limited to the specific implementations disclosed and that modifications and other implementations are intended to be included within the scope of the appended claims. Although specific terms are employed herein, they are used in a generic and descriptive sense only and not for purposes of limitation.

What is claimed is:

1. A device, comprising:
at least one memory that stores computer-executable instructions; and
at least one processor of the one or more processors configured to access the at least one memory, wherein the at least one processor of the one or more processors is configured to execute the computer-executable instructions to:
identify a request from a client device;
cause to send first information to the client device;
identify second information received from the client device, the second information including one or more operational information associated with the client device; and
determine, based at least in part on the second information, to at least one of allocate resources associated with the device to the client device or send the client device third information, the third information including configuration information for resource allocation at the client device.

2. The device of claim 1, wherein the request includes at least one of an authentication request, an association request, or a pre-association discovery request, from the client device.

3. The device of claim 2, wherein the instructions to cause to send the first information to the client device further comprise instructions to initiate an authentication or an association with the client device after receiving at least one of an authentication request or an association request from the client device.

4. The device of claim 3, wherein the instructions to identify second information received from the client device further comprise instructions to determine one or more of capability information or a resource information associated with the client device during the authentication or the association with client device.

5. The device of claim 1, wherein the instructions to identify second information from the client device further comprise instructions to identify one or more of capability information or a resource information associated with the client device.

6. The device of claim 5, wherein the instructions to identify second information received from the client device further comprise instructions to identify a set of pre-determined parameters indicating an operation of the device.

7. The device of claim 6, wherein the instructions to cause to send the first information to the client device further comprise instructions to cause to send fourth information to the client device that comprises instructions describing the set of pre-determined parameters indicating the operation of the device.

8. The device of claim 6, wherein the set of pre-determined parameters indicating the operation of the device comprises a pre-determined channel bandwidth associated with the communication between the device and the client device.

9. The device of claim 1, wherein the instructions to cause to send the first information to the client device further comprise instructions to cause to send to the client device compatibility information that describes capabilities of the device, the capabilities including adaptive resource allocation.

10. The device of claim 1, wherein the instructions to cause to send the first information to the client device further comprise instructions to determine one or more services supported by the client device.

11. The device of claim 1, wherein the instructions to cause to send the third information to the client device is based at least in part on a device type.

12. The device of claim 1, further comprising a transceiver configured to transmit and receive wireless signals and an antenna coupled to the transceiver.

13. The device of claim 12, further comprising communication circuitry to determine the data to be sent by the transceiver.

14. A device, comprising:
at least one memory that stores computer-executable instructions; and
at least one processor of the one or more processors configured to access the at least one memory, wherein the at least one processor of the one or more processors is configured to execute the computer-executable instructions to:
identify data received from a client device;
identify, in the data, statistics associated with at least one activity of the client device;
determine, based at least in part on the statistics, an implementation mode for use in communication with the client device; and
determine resource allocation at one or more of the device and the client device based on the statistics and the implementation mode.

15. The device of claim 14, wherein the instructions to determine an implementation mode further comprise instructions to determine the implementation mode to be an explicit mode.

16. The device of claim 14, wherein the instructions further comprise instructions to inform the client device that a pre-determined configuration information will be applied to the client device based on a discovered behavior of the client device.

17. The device of claim 14, wherein the instructions further comprises instructions to determine whether the client device overrides the application of the pre-determined configuration information to the client device.

18. A device comprising:
at least one memory that stores computer-executable instructions; and
at least one processor of the one or more processors configured to access the at least one memory, wherein the at least one processor of the one or more processors is configured to execute the computer-executable instructions to:
identify data received from a client device;
determine the data includes an explicit client device notification, the explicit client device notification including client device operational information; and
determine resource allocation at one or more of the device and the client device based on client device operational information.

19. The device of claim 18, further comprises instructions to identify a resource allocation change request received from the client device.

20. The device of claim 19, wherein the instructions further comprise instructions to confirm the resource allocation change request from the client device.
